(19) United States
(12) Patent Application Publication
(10) Pub. No.: US 2013/0140930 A1
(43) Pub. Date: Jun. 6, 2013

(54) ELECTRIC ROTATING MACHINE AND METHOD FOR MANUFACTURING A STATOR CORE FOR THE ELECTRIC ROTATING MACHINE

(71) Applicants: Hidetoshi Koka, Hitachi (JP); Satoshi Kikuchi, Naka-gun (JP); Yutaka Matsunobu, Mito (JP); Shigeru Kakugawa, Hitachi (JP); Kohji Maki, Hitachi (JP); Shinji Sugimoto, Hitachi (JP)

(72) Inventors: Hidetoshi Koka, Hitachi (JP); Satoshi Kikuchi, Naka-gun (JP); Yutaka Matsunobu, Mito (JP); Shigeru Kakugawa, Hitachi (JP); Kohji Maki, Hitachi (JP); Shinji Sugimoto, Hitachi (JP)

(21) Appl. No.: 13/817,344

(22) PCT Filed: Aug. 29, 2011
(86) PCT No.: PCT/JP2011/069376

§ 371 Date: Feb. 15, 2013

(30) Foreign Application Priority Data
Sep. 30, 2010 (JP) 2010-220245

(51) Int. Cl. H02K 5/04; H02K 15/02

(52) U.S. Cl. CPC H02K 5/04; H02K 15/02
USPC 310/89; 29/596

(57) ABSTRACT

Electric rotating machine suppressing narrowing of a magnetic path caused by a skin effect in a housing to increase torque, including stator core having e.g. core back and teeth; stator windings wound around the teeth; stator including stator core and stator windings; housing composed of a magnetic body accommodating the stator; rotor disposed for rotation on an inner circumferential side of the stator. An air gap is provided between an inside wall of the housing and an outer circumferential surface of core back. The core back has projections on a radial back surface of a portion where the teeth are provided. The projections are each provided to be continuous in an axial direction and have tip portions in contact with inside wall of the housing. The air gap may be defined by the inside wall of the housing, the outer circumferential surface of the core back and the projections.

### TECHNICAL FIELD

The present invention relates to an electric rotating machine such as a motor or a generator, and a method for manufacturing a stator core for the electric rotating machine.

### BACKGROUND ART

An electric rotating machine for a vehicle, e.g., a motor for driving a hybrid electric vehicle, subjects to constraints in terms of mounting space, whereas they need to obtain high torque from limited battery voltage. To meet such needs, a method for increasing the usage efficiency of magnetic flux has been discussed so far, with the magnetic flux being used to drive an electric rotating machine. For example, Patent Document 1 discloses a technology for reducing an eddy-current loss that will occur at a housing to thereby suppress a torque loss.

### PRIOR ART DOCUMENTS

### Patent Documents

Patent Document 1: JP-2009-153269-A

### SUMMARY OF THE INVENTION

### Problem to be Solved by the Invention

In addition to eddy currents, the narrowing of a flux path caused by the skin effect occurs in the housing. However, the technology disclosed in Patent Document 1 does not particularly take the skin effect into consideration.

It is an object of the present invention, therefore, to provide an electric rotating machine that is configured to suppress the narrowing of a flux path caused by a skin effect at a housing to increase torque.

### Means for Solving the Problem

To solve the above problem, an electric rotating machine of the present invention includes a stator core having e.g. a core back and teeth; stator windings wound around the teeth; a stator including the stator core and the stator windings; a housing composed of a magnetic body and accommodating the stator; and a rotor disposed for rotation on an inner circumferential side of the stator. An air gap is provided between an inside wall of the housing and an outer circumferential surface of the core back.

### Effect of the Invention

The present invention can provide an electric rotating machine that can suppress a skin effect occurring at a housing to increase torque.

### BRIEF DESCRIPTION OF THE DRAWINGS

FIG. 1 is a block diagram illustrating a configuration of a hybrid electric vehicle to which an electric rotating machine embodying the present invention is applied.

FIG. 2 is a circuit diagram illustrating a circuit configuration of an inverter device embodying the present invention.

FIG. 3 is a birds-eye view illustrating the configuration of the electric rotating machine embodying the present invention.

FIG. 4 is a schematic diagram illustrating the sectional structure of the electric rotating machine embodying the present invention.

FIG. 5 is a graph illustrating influences of an eddy-current loss and a skin effect on torque.

FIG. 6 is a graph illustrating the order characteristics of radial magnetic flux.

FIG. 7 is a schematic view illustrating a sectional structure of the electric rotating machine embodying the present invention.

FIG. 8 is a graph illustrating a difference in torque between the installation locations of projections.

FIG. 9 partially illustrates a stator core of an electric rotating machine embodying the present invention.

FIG. 10 illustrates the configuration of the stator core of the electric rotating machine embodying the present invention.

FIG. 11 is a graph illustrating a comparison of order characteristics of radial magnetic flux between a conventional example and the embodiment of the present invention.

### MODE FOR CARRYING OUT THE INVENTION

Embodiments of the present invention will hereinafter be described taking a drive motor used for hybrid electric vehicles as an example.

### Embodiment 1

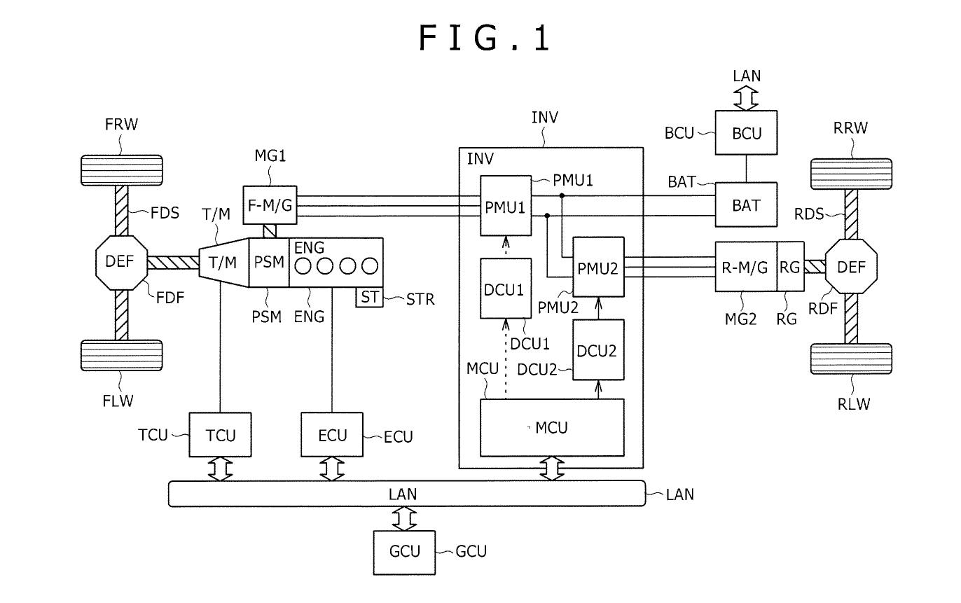

A configuration of a vehicle to which an electric rotating machine of a first embodiment is applied is described with reference to FIG. 1. The present embodiment is described taking a hybrid electric vehicle having two different power sources as an example.

The hybrid electric vehicle of the present embodiment is a four-wheel-drive vehicle configured such that an engine ENG, which is an internal combustion engine, and an electric rotating machine MG1 drive front wheels FLW, FRW and an electric rotating machine MG2 drives rear wheels RLW, RRW. The present embodiment describes the case where the engine ENG and the electric rotating machine MG1 drive the front wheels WFLW, FRW and the electric rotating machine MG2 drives the rear wheels RLW, RRW. However, the hybrid electric vehicle may be configured such that the electric rotating machine MG1 drives the front wheels WFLW, FRW and the engine ENG and the electric rotating machine MG2 drive the rear wheels RLW, RRW.

A transmission T/M is mechanically connected to front axles FDS for the front wheels FLW, FRW via a differential FDF. The electric rotating machine MG1 and the engine ENG are mechanically connected to the transmission T/M via a power distribution mechanism PSM. The power distribution mechanism PSM is a mechanism adapted to control the combination and distribution of rotational drive forces. The AC side of an inverter device INV is electrically connected to stator windings of the electric rotating machine MG1. The inverter device INV is a power conversion device for converting DC power into three-phase AC power and is adapted to control the drive of the electric rotating machine MG1. A battery BAT is electrically connected to the DC side of the inverter device INV.

The electric rotating machine MG2 is mechanically connected to rear axles RDS for the rear wheels RLW, RRW via a differential RDF and a reduction gear RG. The AC side of the inverter device INV is electrically connected to stator windings of the electric rotating machine MG2. Incidentally, the inverter device INV is shared by the electric rotating machines MG1, MG2. In addition, the inverter device INV includes a power module PMU1 and a drive circuit unit DCU1 for the electric rotating machine MG1; a power module PMU2 and a drive circuit unit DCU2 for the electric rotating machine MG2; and a motor control unit MCU.

A starter STR is mounted to the engine ENG. The starter STR is a starting device for starting the engine ENG.

An engine control unit ECU calculates, on the basis of input signals from sensors and other control units, control values used for operating component devices (a throttle valve, a fuel injection valve, etc.) for the engine ENG. The control values are outputted as control signals to drive devices for the component devices for the engine ENG. In this way, the operation of the component devices for the engine ENG is controlled.

The operation of the transmission T/M is controlled by a transmission control unit TCU. The transmission control unit TCU calculates, on the basis of input signals from sensors and other control units, control values used to operate a shifting mechanism. The control values are outputted as control signals to a drive device for the shifting mechanism. In this way, the operation of the shifting mechanism for the transmission T/M is controlled.

The battery BAT is a lithium ion battery with a high battery-voltage of 200 V or higher. In addition, the charge-discharge, operating life and the like of the battery BAT is controlled by a battery control unit BCU. To control the charge-discharge, operating life and the like of the battery, the voltage value, current value and the like of the battery BAT are inputted to the battery control unit BCU. Although illustration is omitted, also a low-voltage battery with a battery-voltage of 12 V is mounted on the vehicle as a battery and used as a power source for a control system and for a radio, lights and the like.

The engine control unit ECU, the transmission control unit TCU, the motor control unit MCU and the battery control unit BCU are electrically connected with each other via an onboard local area network LAN and with a general control unit GCU. This allows for interactive signal transmission among the control units, which enables mutual information transmission and shared detection values. The general control unit GCU is adapted to output command signals to the control units in response to the operating conditions of the vehicle. For example, the general control unit GCU calculates a necessary torque value of the vehicle in response to an accelerator depression amount based on driver's acceleration demand. This necessary torque value is divided into an output torque value on the engine ENG side and an output torque value on the electric rotating machine MG1 so that the operation efficiency of the engine ENG may be increased. The divided output torque value on the engine ENG side is outputted as an engine torque command signal to the engine control unit ECU. In addition, the divided output torque value on the electric rotating machine MG1 side is outputted as a motor torque command signal to the motor control unit MCU.

A description is next given of the operation of the hybrid electric vehicle of the present embodiment.

During the startup or low-speed traveling of the hybrid electric vehicle (in the traveling range where the operation efficiency of the engine ENG is lowered), the electric rotating machine MG1 drives the front wheels FLW, FRW. Incidentally, the present embodiment describes the case where the electric rotating machine MG1 drives the front wheels FLW, FRW during the startup or low-speed traveling of the hybrid electric vehicle. However, the hybrid electric vehicle may be operated such that the electric rotating machine MG1 drives the front wheels FLW, FRW and the electric rotating machine MG2 drives the rear wheels RLW, RRW (the hybrid electric vehicle may 4WD-travel). DC power is supplied from the battery BAT to the inverter device INV. The DC power thus supplied is converted into three-phase AC power by the inverter device INV. The three-phase AC power thus obtained is supplied to the stator windings of the electric rotating machine MG1. In this way, the electric rotating machine MG1 is driven to generate rotative power. This rotative power is inputted to the transmission T/M via the power distribution mechanism PSM. The rotative power thus inputted is increased or reduced by the transmission T/M and is inputted to the differential FDF. The rotative power thus inputted is divided between right and left by the differential FDF and transmitted to the left and right front axles FDS. Thus, the front axles FDS are rotatably driven to rotatably drive the front wheels FLW, FRW.

During the normal running of the hybrid electric vehicle (in the case of running on a dry road surface and in a running range where the operation efficiency (fuel consumption) of the engine ENG is satisfactory), the engine ENG drives the front wheels FLW, FRW. To that end, the rotative power of the engine ENG is inputted into the transmission T/M via the power distribution mechanism PSM. The rotative power thus inputted is changed in speed by the transmission T/M. The rotative power thus changed in speed is transmitted to the front axles FDS via the differential FDF. Thus, the front wheels FLW, FRW are rotatably driven. The charging condition of the battery BAT is detected. If it is necessary to charge the battery BAT, the rotative power of the engine ENG is distributed to the electric rotating machine MG1 via the power distribution mechanism PSM to rotatably drive the electric rotating machine MG1. In this way, the electric rotary machine MG1 operates as a generator. This operation generates three-phase AC power in the stator windings of the electric rotating machine MG1. The three-phase AC power thus generated is converted into predetermined DC power by the inverter device INV. The DC power thus obtained by the conversion is supplied to the battery BAT. Thus, the battery BAT is charged.

During the 4WD running of the hybrid electric vehicle (in the case of running on a low-p road such as a snowy road or the like and in the running range where the operation efficiency (fuel consumption) of the engine ENG is satisfactory, the electric rotating machine MG2 drives the rear wheels RLW, RRW. In addition, the engine ENG drives the front wheels FLW, FRW similarly to the normal running. The storage amount of the battery BAT is reduced by driving the electric rotating machine MG1. Therefore, similarly to the normal running described above, the rotative power of the engine ENG rotatably drives the electric rotating machine MG1 to charge the battery BAT. To drive the rear wheels RLW, RRW by the electric rotating machine MG2, the DC power is supplied from the battery BAT to the inverter device INV. The DC power thus supplied is converted into three-phase AC power by the inverter device INV. The AC power thus obtained is supplied to the stator windings of the electric rotating machine MG2. In this way, the electric rotating machine MG2 is driven to generate rotative power. The rotative power thus generated is reduced in speed by the reduction gear RG and is inputted to the differential RDF. The rotative power thus inputted is divided between right and left by the differential RDF and transmitted to the left and right rear axles RDS. Thus, the rear axles RDS are rotatably driven. The rear axles RDS are rotatably driven to rotatably drive the rear wheels RLW, RRW.

During the acceleration of the hybrid electric vehicle, the engine ENG and the electric rotary vehicle MG1 drive the front wheels FLW, FRW. Incidentally, the present embodiment describes the case where during the acceleration of the hybrid electric vehicle, the engine ENG and the electric rotating machine MG1 drive the front wheels FLW, FRW. However, the hybrid electric vehicle may be operated such that the engine ENG and the electric rotating machine MG1 drive the front wheels FLW, FRW and the electric rotating machine MG2 drives the rear wheels RLW, RRW (the hybrid electric vehicle may 4WD-travel). The rotative power of the engine ENG and the electric rotating machine MG1 is inputted to the transmission T/M via the power distribution mechanism PSM. The rotative power thus inputted is changed in speed by the transmission T/M. The rotative power thus changed in speed is transmitted to the front axles FDS via the differential FDF. Thus, the front wheels FLW, FRW are rotatably driven.

During the regeneration of the hybrid electric vehicle (during deceleration such as during the depression of a brake pedal, during the release of the depression of an accelerator or during the stoppage of the depression of the accelerator), the rotative force of the front wheels FLW, FRW is transmitted via the front axles FDS, the differential FDF, the transmission T/M and the power distribution mechanism PSM to the electric rotating machine MG1 to rotatably drive the electric rotating machine MG1. This operates the electric rotating machine MG1 as a generator. This operation generates three-phase AC power in the stator windings of the electric rotating machine MG1. The three-phase AC power thus generated is converted into predetermined DC power by the inverter device INV. The DC power thus obtained by this conversion is supplied to the battery BAT. Thus, the batter BAT is charged. On the other hand, the rotative force of the rear wheels RLW, RRW is transmitted via the rear axles RDS, the differential RDF and the reduction gear RG to the electric rotating machine MG2 to rotatably drive the electric rotating machine MG2. This operates the electric rotating machine MG2 as a generator. This operation generates three-phase AC power in the stator windings of the electric rotating machine MG2. The three-phase AC power thus generated is converted into predetermined DC power by the inverter device INV. The DC power obtained by this conversion is supplied to the battery BAT. Thus, the battery BAT is charged.

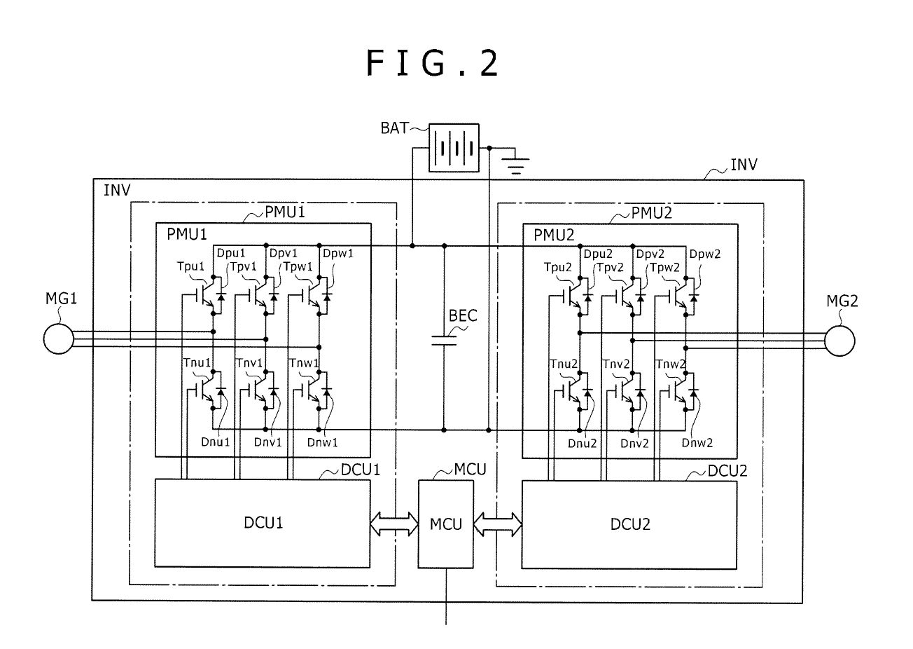

FIG. 2 illustrates the configuration of the inverter device INV according to the present embodiment.

As described earlier, the inverter device INV includes the power modules PMU1, PMU2, the drive circuit units DCU1, DCU2 and the motor control unit MCU. The power module units PMU1, PMU2 have the same configuration. The drive circuit units DCU1, DCU2 have the same configuration.

The power modules PMU1, PMU2 constitute respective conversion circuits (also called main circuits) adapted to convert the DC power supplied from the battery BAT into AC power and supply it to the corresponding electric rotating machines MG1, MG2. The conversion circuits can convert the AC power supplied from the corresponding electric generating machines MG1, MG2 to DC power and supply the DC power to the battery BAT.

The conversion circuit is a bridge circuit which is configured such that in-line circuits for three-phases are electrically connected in parallel between the positive side and negative side of the battery BAT. The in-line circuit is also called an arm, which is composed of two semiconductor devices.

The arm for each phase is configured such that a power semiconductor device on an upper arm side and a power semiconductor device for a lower arm side are electrically connected in series. The present embodiment uses as a power semiconductor device an IGBT (an insulated gate bipolar transistor), which is a switching semiconductor device. A semiconductor chip constituting the IGBT includes three electrodes: a collector electrode, an emitter electrode and a gate electrode. A diode of a chip different from the IGBT is electrically connected between the collector electrode and emitter electrode of the IGBT. The diode is electrically connected between the emitter electrode and collector electrode of the IGBT so that a direction extending from the emitter electrode toward collector electrode of the IGBT may be a forward direction. Incidentally, a MOSFET (a metal-oxide semiconductor field-effect transistor) may be used as the power semiconductor device in place of the IGBT in some cases. In this case, the diode is omitted.

The emitter electrode of the power semiconductor device Tpu1 and the collector electrode of the power semiconductor device Tnu1 are electrically connected in series to form a u-phase arm of the power module PMU1. Also a v-phase arm and a w-phase arm are each formed similarly to the u-phase arm. The emitter electrode of the power semiconductor device Tpv1 and the collector electrode of the power semiconductor device Tnv1 are electrically connected in series to form a v-phase arm of the power module PMU1. The emitter electrode of the power semiconductor device Tpw1 and the collector electrode of the power semiconductor device Tnw1 are electrically connected in series to form a w-phase arm of the power module PMU1. Also the power module PMU2 is such that arms for associated phases are formed to have the same connecting relationship as that of the power module PMU1 described above.

The respective collector electrodes of the power semiconductor devices Tpu1, Tpv1, Tpw1, Tpu2, Tpv2, Tpw2 are electrically connected to the high-potential side (the positive electrode side) of the battery BAT. The respective emitter electrodes of the power semiconductor devices Tnu1, Tnv1, Tnw1, Tnu2, Tnv2, Tnw2 are electrically connected to the low-potential side (the negative electrode side) of the battery BAT.

A midpoint (a connecting portion between the emitter electrode of the upper arm side power semiconductor device and the collector electrode of the lower arm side power semiconductor electrode in each of the arms) of the u-phase arm (the v-phase arm and the w-phase arm) of the power module PMU1 is electrically connected to the stator windings of the u-phase (the v-phase and the w-phase) of the electric rotating machine MG1.

A midpoint (a connecting portion between the emitter electrode of the upper arm side power semiconductor device and the collector electrode of the lower arm side power semiconductor electrode in each of the arms) of the u-phase arm (the v-phase arm and the w-phase arm) of the power module PMU2 is electrically connected to the stator windings of the u-phase (the v-phase and the w-phase) of the electric rotating machine MG2.

A smoothing electrolytic capacitor SEC is electrically connected between the positive electrode side and negative electrode side of the battery BAT in order to suppress variations in DC voltage caused by the operation of the power semiconductor devices.

The drive circuit units DCU1, DCU2 are configured as drive sections adapted to output, on the basis of the control signals output from the motor control unit MCU, drive signals for operating the power semiconductor devices of the power modules PMU1, PMU2, thereby operating the power semiconductor devices. In addition, the drive circuit units DCU1, DCU2 are each composed of circuit components such as an insulated power source, an interface circuit, a drive circuit, a sensor circuit and a snubber circuit (their illustrations are omitted).

The motor control unit MCU is an arithmetic device composed of a microcomputer. The motor control unit MCU receives a plurality of input signals and outputs, to the drive control circuits DSU1, DSU2, control signals for operating the power semiconductor devices of the power modules PMU1, PMU2. The motor control circuit MCU receives, as the input signals, torque command values τ*1, τ*2, current detection signals iu1 to iw1, iu2 to iw2, and magnetic pole position signals θ1, θ2.

The torque command values τ*1, τ*2 are outputted from an upper control unit in response to the operation mode of the vehicle. The torque command value t*1 corresponds to the electric rotating machine MG1 and the torque command value τ*2 corresponds to the electric rotating machine MG2. The current detection signals iu1 to lw1 are detection signals of input currents of u- to w-phases supplied from the conversion circuit of the inverter device INV to the stator windings of the electric rotating machine MG1. In addition, the current detection signals iu1 to lw1 are each detected by a current sensor such as a current transformer (CT). The current detection signals iu2 to lw2 are detection signals of input currents of u- to w-phases supplied from the inverter device INV to the stator windings of the electric rotating machine MG2. In addition, the current detection signals iu2 to lw2 are each detected by a current sensor such as a current transformer (CT). A magnetic pole position detection signal θ is a detection signal of a magnetic pole position of the rotation of the electric rotating machine MG1 and is detected by a magnetic pole position sensor such as a resolver, an encoder, a Hole element, a Hole IC or the like. A magnetic pole position detection signal θ2 is a detection signal of a magnetic pole position of the rotation of the electric rotating machine MG1 and is detected by a magnetic pole position sensor such as a resolver, an encoder, a Hole element, a Hole IC or the like.

The motor control unit MCU calculates voltage control values on the basis of the input signals and outputs, to the drive circuit units DCU1, DCU2, the voltage control value as control signals (a PWM signal (a pulse width modulation signal)) for operating the power semiconductor devices Tpu1 to Tnw1, Tpu2 to Tnw2 of the power modules PMU1, PMU2.

The PWM signals outputted by the motor control unit MCU are generally designed such that hourly-averaged voltage has a sine wave. In this case, the instantaneous maximum output voltage is the voltage of a DC line, which is an input of the inverter. Therefore, if the voltage of the sine wave is outputted, its effective value is 1/√2. Thus, in the hybrid electric vehicle of the present invention, the effective value of the input voltage of the motor is increased in order to further increase the power of the motor by the limited inverter device. Specifically, the PWM signal of the MCU is made to have only ON and OFF in square-wave form. In this way, the wave-height value of the square-wave is voltage Vdc of the DC line of the inverter and its effective value is Vdc. This is a method for maximizing the voltage effective value.

However, the square-wave voltage has small inductance in a low rotation speed range, which leads to a problem with a turbulent current waveform. This allows the motor to produce unnecessary excitation force, which makes noises. Thus, the square-wave voltage control is used only during high-speed rotation, whereas the usual PWM control is exercised in low-frequencies.

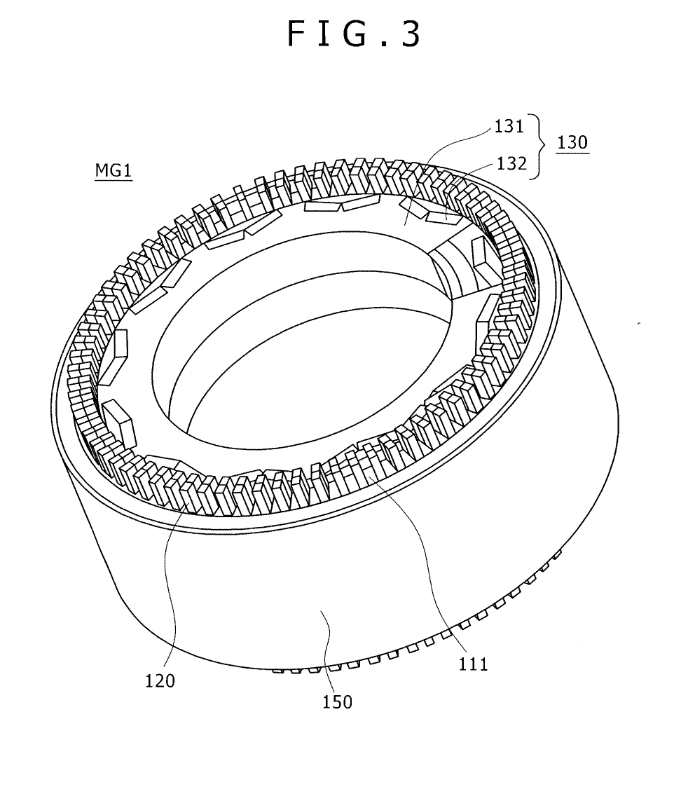

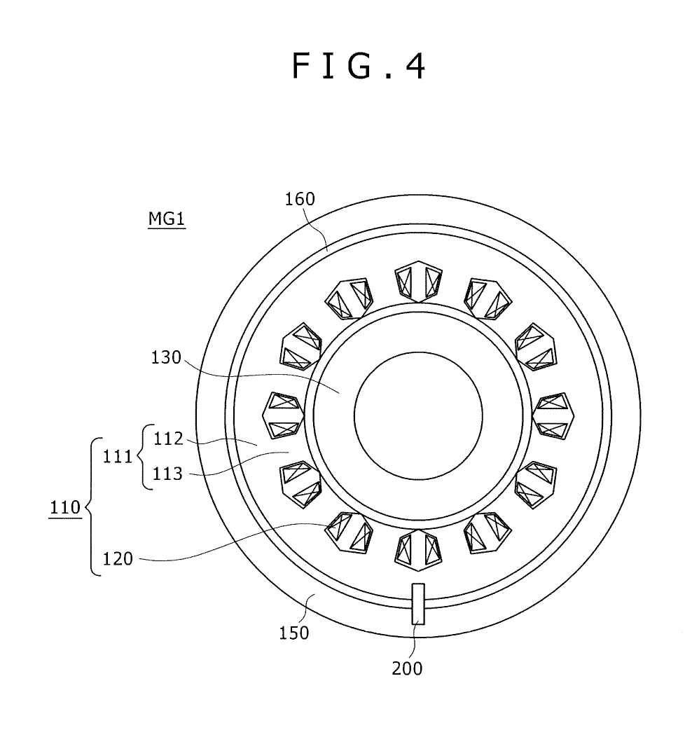

FIGS. 3 and 4 illustrate the electric rotating machine MG1 of the present embodiment. FIG. 3 is a perspective view and FIG. 4 is a schematic view of the electric rotating machine depicted by changing the proportions of components for simplicity. Incidentally, the same components are denoted by like reference numerals.

The present embodiment describes an embedded type permanent magnet three-phase AC synchronous machine used as the electric rotating machine MG1 by way of example. Incidentally, the present embodiment describes the configuration of the electric rotating machine MG1; however, also the electric rotating machine MG2 has the same configuration as that of the electric rotating machine MG1.

The electric rotating machine MG1 has a stator 110 adapted to generate a rotating field and a rotor 130 which is rotated by magnetic action with the stator 110 and is disposed for rotation with an air gap 160 defined in cooperation with the inner circumferential side of the stator 110.

The stator 110 has a stator core 111 composed of a core back 112 and teeth 113; and slots into which stator windings 120 are inserted. The stator windings 120 generate magnetic flux through energization.

The stator core 111 is formed of cast-iron or formed by axially stacking a plurality of plate-like formed members formed by punching a plate-like magnetic member. Incidentally, the axial direction means a direction extending along the rotation axis of the rotor.

The stator windings 120 are inserted into the slots and brought into a state of being wound around the teeth 113.

A housing 150 is installed around the stator core 111. The housing 150 is formed of a magnetic body and used as a magnetic path.

The rotor 130 includes a stator core 131 forming a rotation side magnetic path, permanent magnets 132 and a shaft (not shown) serving as a rotating shaft.

An air gap 160 is at least partially provided between the inside wall of the housing 150 and the outer circumferential surface of the core back 112. The provision of the air gap 160 between the inside wall of the housing 150 and the outer circumferential surface of the core back 112 as described above can increase the torque of the electric rotating machine MG. That reason is described below.

Torque is calculated by the finite element method if the electric conductivity of the housing 150 is set at 0.0 S/m and if the skin effect is considered. A calculation condition is such that magnetic permeability of high-carbon steel is assumed as that of the housing 150.

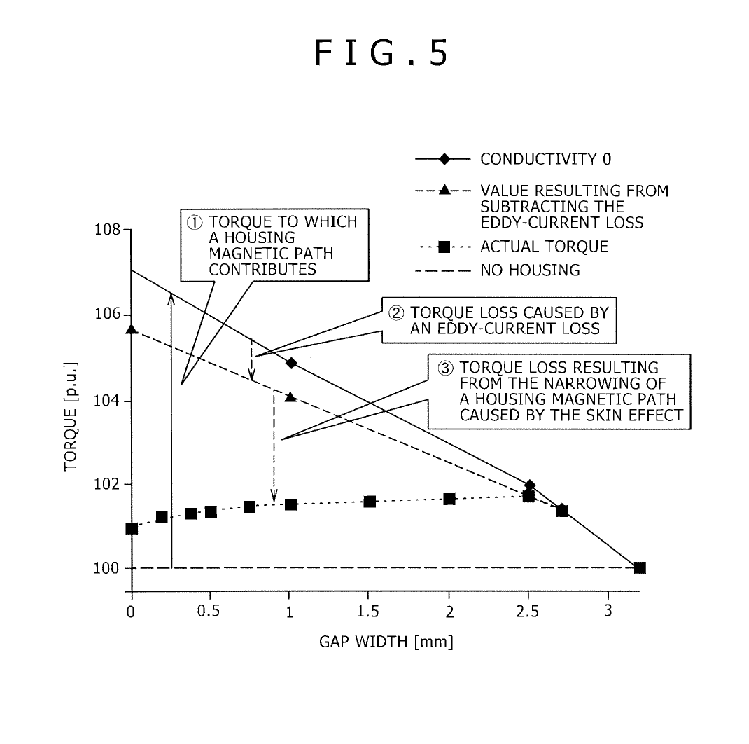

FIG. 5 shows torque characteristics under various conditions. The horizontal axis represents the width of the air gap and the longitudinal axis represents torque encountered if torque is 100 in the case of the absence of the housing 150. Incidentally, the width of the air gap indicates the distance of the air gap 160 between the outer circumferential surface of the core back 112 and the inside wall of the housing 150. In view of the characteristic encountered when the width of the air gap is 0 mm, the torque encountered when the housing 150 is absent may be assumed as 100. In such a case, with particular consideration given to the housing 150 and when the conductivity is set at 0.0 S/m, the torque measured is 107, which indicates an increase of 7. This is (1) torque to which the housing magnetic path contributes. However, torque is 101 if the condition of actual torque is taken as a conductivity of 7,000,000 S/m. This seems due to (2) a torque loss caused by an eddy-current loss occurring at the housing 150. Therefore, if the loss is subtracted from a torque of 107, torque is 106. Nevertheless a difference of 5 occurs with respect to a torque of 101, i.e., the actual torque, where particular consideration is given to the housing 150. It will be seen that this value is (3) the torque loss resulting from the narrowing of the housing magnetic path caused by the skin effect. These results show that the torque loss is dominated not by the eddy-current loss occurring at the housing 150 but by the narrowing of the magnetic path caused by the skin effect.

A calculation was performed on the assumption that the air gap 160 is provided between the housing 150 and the stator core 111. It will been seen that if the width of the air gap, which is indicated on the horizontal axis of FIG. 5, is increased, then the skin effect is reduced, and the actual torque is increased until an air gap width of 2.5 mm is reached.

A description is given of the reason why the narrowing of the magnetic path is reduced. Magnetic flux penetration depth 6 is represented by the following formula.

$$Magnetic flux penetration depth δ = \sqrt{\frac{2}{ω σ μ}} \qquad [ Formula 1 ]$$

In the above formula, ω is the frequency [rad/s] of the magnetic flux, σ is the conductivity [S/m] of the housing or a member between the housing and the stator core, and μ is the magnetic permeability [H/m] of the housing or a member between the housing and the stator core.

The above formula shows that the magnetic flux penetration depth can be increased if at least one of ω, σ and μ is reduced. It may be probable that the provision of the air gap 160 between the housing 150 and the stator core 111 reduces σ and μ, while the magnetic flux penetration depth δ enlarges and the torque increases.

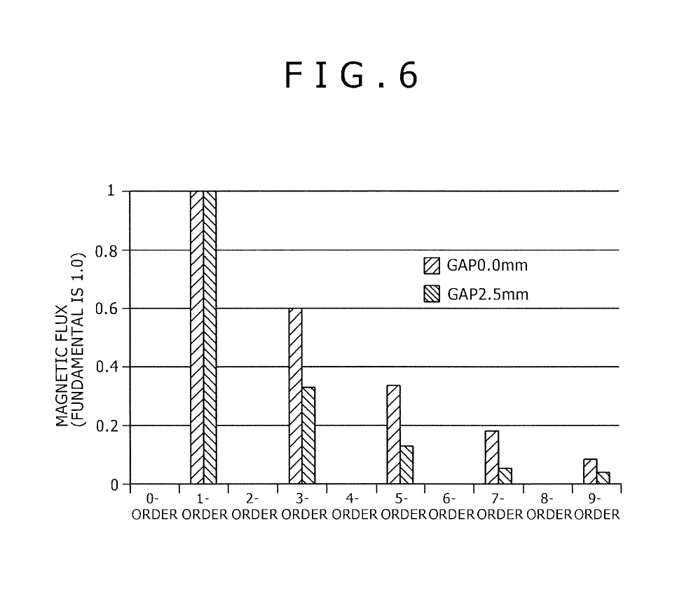

FIG. 6 is a graph in which time waveform of the radial magnetic flux of the outer diameter portion of the stator is subjected to order analysis. A fundamental (first-order) is here defined as 1.0. If the air gap 160 is not provided (in the case of GAP 0.0 mm in FIG. 6), the graph shows that spatial harmonic occurs in the inside diameter portion of the housing 150, which will increase ω. In addition, the graph shows that if the air gap 160 is set at 2.5 mm, third-order harmonic is reduced from 0.6 to 0.3 and also harmonics associated with other orders are reduced. Also this shows that ω is reduced, which makes it possible for the magnetic flux to penetrate deeply.

Incidentally, torque drops if the gap width exceeds 2.5 mm, because the housing 150 is reduced in width and it becomes hard for the housing to act as the magnetic path.

As described above, the provision of the air gap 160 between the inside wall of the housing 150 and the outer circumferential surface of the core back 112 can reduce the skin effect and increase torque.

In the present embodiment, a non-magnetic metal material is disposed or filled in the air gap 160 in order to suppress the stagger of the stator 110 and a retainer 200 is provided in order to suppress the turning of the stator 110. The non-magnetic metal material is here e.g. aluminum or non-magnetic stainless steel. Even if a non-magnetic metal material is disposed or filled in the air gap 160, the effect of increasing torque described above can be obtained. In addition, strength can be more increased and radiation performance can be more improved.

### Embodiment 2

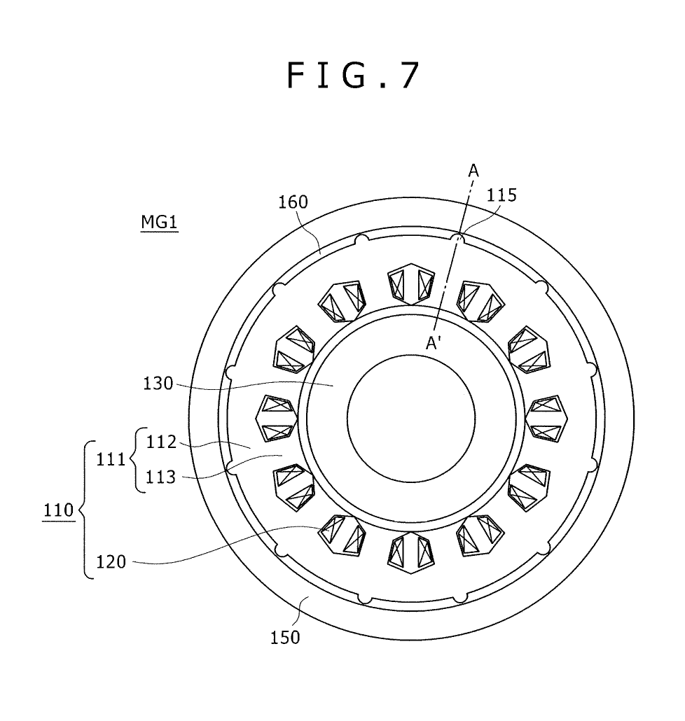

Another embodiment of the present invention is described with reference to FIG. 7.

In the first embodiment, the turning of the stator core 111 is prevented by the retainer 200. In the present embodiment, a plurality of projections 115 are axially provided on the stator core 111 of the first embodiment. This defines the contact portions between the stator core 111 and the housing 150, thereby further improving reliability. These projections 115, the inside wall of the housing 150 and the core back 112 define an air gap 160.

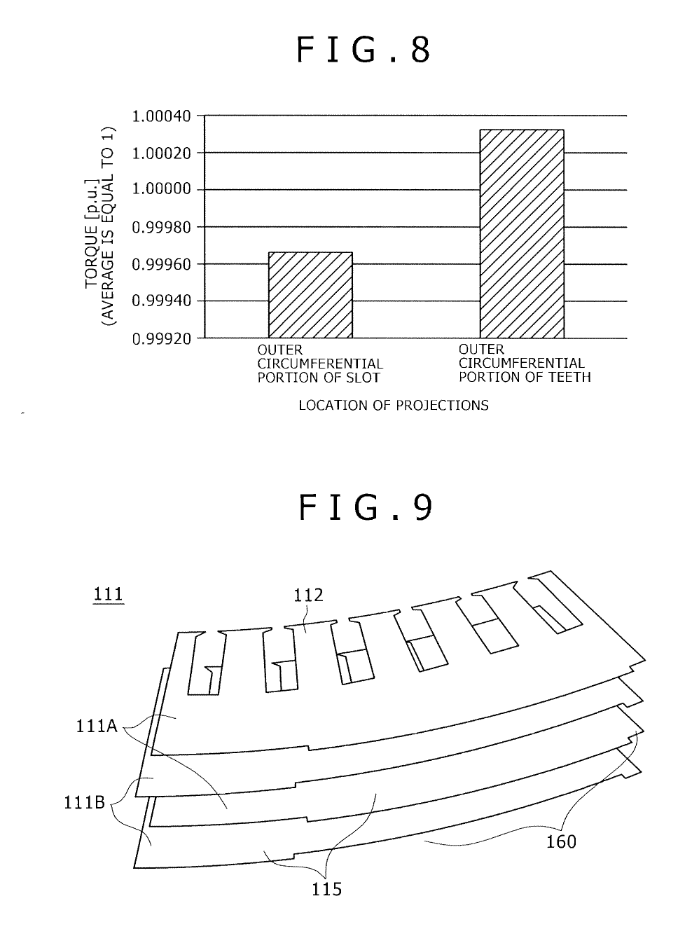

The projections 115 are provided so as to be located on the radial back surface of the teeth 113 as indicated by a straight line A-A′ of FIG. 7. This is because torque is more increased if the projections 115 are provided on the outer circumferential portion of the teeth 113 than on the outer circumferential portion of the slots as shown in FIG. 8. This structure can concurrently achieve an improvement in reliability and an increase in torque.

The projections 115 are provided in the axial direction; therefore, the air gap 160 is formed in the axial direction. In particular, the electric rotating machine for driving the hybrid electric vehicle has a casing shorter in the axial direction than e.g. a power steering motor. Therefore, it is possible to more reduce the skin effect in comparison with the case in which the air gap 160 is defined in the circumferential direction.

### Embodiment 3

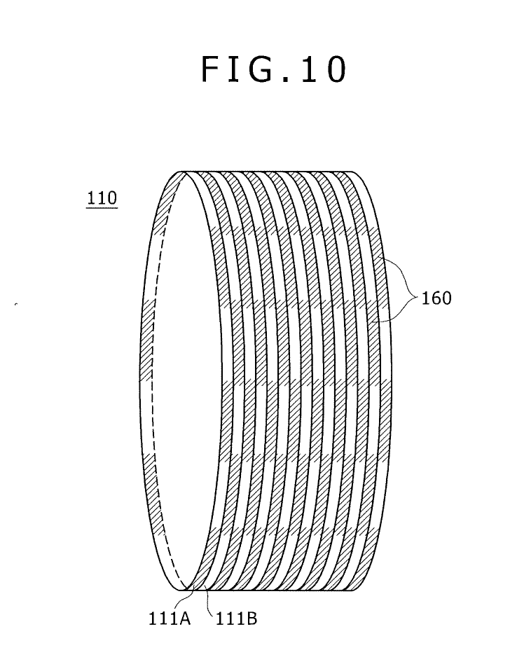

Another embodiment of the present invention is described with reference to FIGS. 9 and 10. FIG. 9 is a partially enlarged view of a stator core 111. FIG. 10 is a schematic view of the outer circumferential portion of the stator 110. Incidentally, FIG. 10 omits the illustration of teeth 112.

In the present embodiment, electromagnetic steel plates are each provided with concave portions and convex portions on its outer edge portion. The electromagnetic steel plates thus formed are stacked in the axial direction to constitute a stator core 111. Incidentally, the convex portion of the outer edge portion of the electromagnetic steel plate corresponds to a projection 115 and the concave portion corresponds to an air gap 160. These electromagnetic steel plates are stacked in a staggered manner, which can make the air gaps 160 skew.

The electromagnetic steel plates may be stacked alternately with respect to the front and back thereof. This can suppress the accumulation, due to the stacking, of strain occurring during the press forming of the electromagnetic steel plate, thereby further improving reliability.

The electromagnetic steel plates used in the present embodiment may be of one type having the same shape. As shown in FIG. 10, the electromagnetic steel plates of one type are stacked alternately with respect to the front and back thereof so as to be different in position from each other. Thus, the air gaps 160 can each be skewed without the preparation of a plurality of types of the electromagnetic steel plates.

In FIGS. 9 and 10, reference numeral 111A denotes electromagnetic steel plates disposed with their front surfaces and 111B denotes electromagnetic steel plates disposed with their rear surfaces.

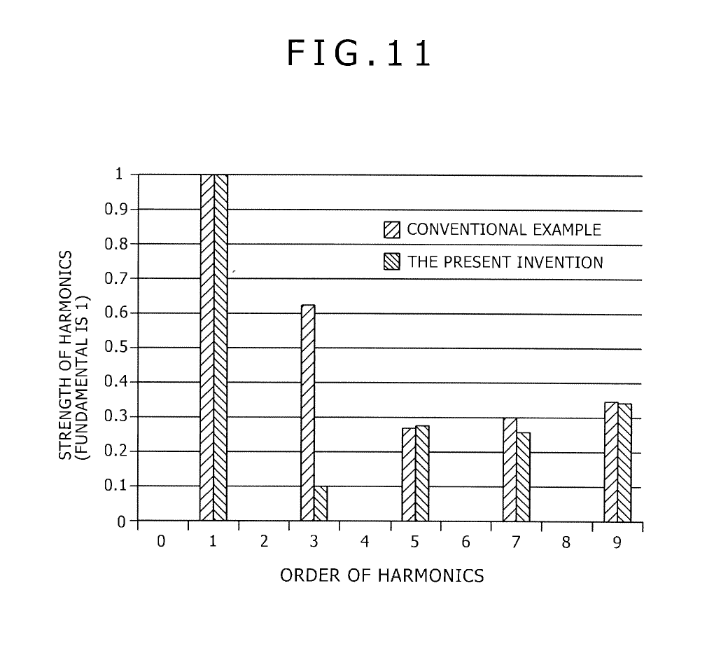

FIG. 11 shows results obtained by FFT-analyzing magnetic flux density distributions, in the radial direction, of a stator core having a conventional structure and of the stator core 111 of the present embodiment. The longitudinal axis represents magnetic flux density encountered when the first-order harmonic (fundamental) is set at 1 and the horizontal axis represents the order of harmonic. FIG. 11 shows that the stator core 111 of the present embodiment reduces particularly spatial third-order harmonic, with the result that the torque of the electric rotating machine is more increased.

In any of the embodiments described above, a non-magnetic metal material such as aluminum or non-magnetic stainless steel is disposed or filled in the air gap 160, which makes it possible to more increase strength and improve radiation performance.

Each of the embodiments described above solves the problems mentioned below and produces the effects mentioned below. These problems to be solved and the effects partially overlap the problem to be solved and the effect mentioned earlier; however, most of them are different from the problem to be solved and the effect mentioned earlier.

In each of the embodiments, the stator can be formed by axially stacking the electromagnetic steel plates of one type alternately with respect to the front and back thereof as shown in FIG. 10. With the structure as above, it is not necessary to prepare a plurality of types of electromagnetic steel plates, which improves productivity. Further, the structure as above can avoid the accumulation of the rolling stress due to the stacking of the electromagnetic steel plates of one type.

For example, it is desired to downsize a motor for a hybrid electric vehicle in order to mount it in an engine room. If the present invention is applied to the motor, the motor can be increased in torque compared with an electric rotating machine having the same size, which can contribute to the downsizing of the motor.

As described above, the present invention allows the skin effect to reduce, thereby increasing torque. The above embodiments describe the inner rotor type electric rotating machine by way of example; however, the present invention can be applied to outer rotor type electric rotating machines. The present invention is not limited to the above embodiments as long as the characteristics of the present invention are not impaired.

### DESCRIPTION OF REFERENCE NUMERALS

110 Stator, 111 Stator core, 112 Core back, 113 Teeth, 120 Stator winding, 130 Rotor, 150 Housing, 160 Air gap, 200 Retainer, MG1 Electric rotating machine

1. An electric rotating machine comprising:
a stator core including a core back and teeth;
stator windings wound around the teeth;
a stator including the stator core and the stator windings;
a housing composed of a magnetic body and accommodating the stator; and
a rotor disposed for rotation on an inner circumferential side of the stator;
wherein an air gap is provided between an inside wall of the housing and an outer circumferential surface of the core back.

2. The electric rotating machine according to claim 1,
wherein the core back has a projection on a radial back surface of a portion where the teeth are provided,
the projection is provided so as to be continuous in an axial direction,
the projection has a tip portion in contact with the inside wall of the housing, and
the air gap is defined by the inside wall of the housing, the outer circumferential surface of the core back and the projection.

3. The electric rotating machine according to claim 1,
wherein the stator core is composed of a plurality of electromagnetic steel plates stacked in the axial direction,
the electromagnetic steel plate has the projection at an outer edge portion thereof,
the electromagnetic steel plates adjacent to each other are stacked in such a manner that the projections are disposed at respective positions different from each other in a circumferential direction, and
the air gap is defined by the inside wall of the housing, the outer circumferential surface of the core back and the projection.

4. The electric rotating machine according to claim 1,
wherein a non-magnetic metal material is disposed or filled in the air gap.

5. The electric rotating machine according to claim 2,
wherein the projection is made to skew in the axial direction.

6. A method for manufacturing a stator core for an electric rotating machine, the electric rotating machine including
a housing composed of a magnetic body,
a stator core located inside the housing, and
a rotor disposed for rotation on an inner circumferential side of the stator core,
wherein the stator core is composed by axially stacking a plurality of electromagnetic steel plates alternately with respect to front and back thereof, the electromagnetic steel plates having a shape of one type with a projection at an outer edge portion thereof.

7. The method for manufacturing a stator core for an electric rotating machine according to claim 6,
wherein a non-magnetic metal material is disposed or filled in an air gap, the air gap being defined by an inside wall of the housing, an outer circumferential surface of the stator core and the projection.
